(19) United States
(12) Patent Application Publication
(10) Pub. No.: US 2025/0375802 A1
(43) Pub. Date: Dec. 11, 2025

(54) DUCTLESS OR DUCTED FUMEHOOD WITH IMPROVED FRONT SASH CLOSURE

(71) Applicant: FIPAK Research And Development Company, Rowley, MA (US)

(72) Inventors: Stephane Hauville, Rowley, MA (US); Antoine Hauville, La Londe (FR); Cédric Herry, Val de Reuil (FR)

(21) Appl. No.: 19/233,246

(22) Filed: Jun. 10, 2025

Related U.S. Application Data
(60) Provisional application No. 63/658,048, filed on Jun. 10, 2024.

(51) Int. Cl. B08B 15/02; B08B 13/00

(52) U.S. Cl. CPC B08B 15/023; B08B 13/00

(57) ABSTRACT

A front closure for a fumehood comprising a workspace defined by a frame, the front closure comprising: a front pane having a central opening formed therein; and a movable pane configured to be disposed within the central opening so as to selectively close off a portion of the central opening, wherein the movable pane comprises a left side panel, a right side panel and a front panel extending between the left side panel and the right side panel.

### REFERENCE TO PENDING PRIOR PATENT APPLICATION

This patent application claims benefit of pending prior U.S. Provisional Patent Application Ser. No. 63/658, 048, filed Jun. 10, 2024 by FIPAK Research And Development Company and Stephane Hauville et al. for ALTERNATIVE NOVEL SASH WITH MOVABLE CLOSURE (Attorney's Docket No. FIPAK-35 PROV), which patent application is hereby incorporated herein by reference.

### FIELD OF THE INVENTION

This invention relates to air filtration systems in general, and more particularly to fumehoods comprising a front opening configured to selectively enclose a workspace such that the workspace is isolated (or substantially isolated) from the ambient air, whereby to allow dangerous substances to be safely handled in the enclosed workspace without endangering nearby personnel.

### BACKGROUND OF THE INVENTION

Air filtration systems are used in many situations to purge unwanted substances from the air. Such air filtration systems generally exist in a variety of forms, depending upon their use and function.

One type of air filtration system is the fumehood. Fumehoods provide an enclosed workspace which is isolated (or substantially isolated) from the ambient air in order to allow dangerous substances to be safely handled in the enclosed workspace without endangering nearby personnel. As used herein, the term “fumehood” is intended to encompass any enclosed space configured for working with hazardous materials or agents which utilizes negative air pressure to protect an operator from the materials or agents being manipulated in the enclosed space. By way of example but not limitation, the term “fumehood” as used herein encompasses “fume cupboard”, “chemical hood”, “exhaust hood”, “laboratory hood”, “ventilation hood”, “ducted hood”, “ductless fume hood”, “safety hood”, “containment hood”, “airflow hood”, etc.

Fumehoods are generally either ducted or ductless. Ducted fumehoods are configured to purge hazardous substances from the air of the enclosed workspace before venting that air to the ambient atmosphere. Ductless fumehoods are configured to purge hazardous substances from the air of the enclosed workspace before venting that air to the ambient air of the room containing the ductless fumehood.

The present invention is applicable to both ducted and ductless fumehoods. For purposes of illustration but not limitation, the present invention will now be discussed in the context of ductless fumehoods.

More particularly, and looking now at FIGS. 1 and 2, there is shown a typical prior art ductless fumehood 5. Ductless fumehood 5 generally comprises an enclosed workspace 10 defined by a frame 12 and accessed by a front sash closure 15, with front sash closure 15 engaging a workbase 20 when the enclosed workspace is “sealed”. An air inlet 25 admits ambient air into enclosed workspace 10, and an air vent 30 removes air from enclosed workspace 10. Air from air vent 30 is passed through a filter 35 before being returned to the ambient air of the room (e.g., a laboratory) containing ductless fumehood 5 via an air outlet 37. Filter 35 removes hazardous substances from the air, thereby rendering the air safe before it is returned to the ambient air. An outlet fan 40 is generally provided between air vent 30 and air outlet 37 so as to keep enclosed workspace 10 at a negative pressure differential relative to the ambient air, whereby to ensure that any air within enclosed workspace 10 passes through filter 35 before being returned to the ambient air. A sensor 45 is generally provided at (or downstream of) filter 35 so as to ensure that the filter purges any hazardous substances from the workspace air before that air is returned to the ambient air. Outlet fan 40 and sensor 45 are generally connected to an alarm 50 which can alert personnel in the event that filter 35, outlet fan 40 and/or sensor 45 fail.

Ductless fumehoods have become popular due to their technical effectiveness, low acquisition and implementation costs, rapid installation and substantial energy savings. More particularly, with proper filter selection, ductless fumehoods can be extremely effective in removing hazardous substances from the air of a workspace. Furthermore, due to their simple design and their ductless nature, ductless fumehoods are relatively inexpensive to manufacture and relatively inexpensive to implement, since they do not require the extensive engineering and installation efforts normally associated with ducted fumehoods. Furthermore, installation of ductless fumehoods is fast and simple, since ductless fumehoods require little more than uncrating and initial setup and testing before use. Ductless fumehoods are also extremely energy efficient, since they return the filtered air to the ambient air of the room rather than venting the filtered air to the outside atmosphere. As a result, already-heated air is retained in the room during winter and already-cooled air is retained in the room during summer, thereby minimizing the energy required to temperature-condition the air in the room.

With ductless fumehoods, it is important to manage the airflow out of enclosed workspace 10 in order to ensure that all hazardous substances are removed from the workspace air before it is allowed to return to the ambient air of the room. Ideally, this means that all of the enclosed workspace air is passed through filter 35 before that air is allowed to return to the ambient air of the room. In practice, however, this is difficult to ensure, inasmuch as personnel must typically repeatedly and actively access enclosed workspace 10 through front sash closure 15, and hence some air from the enclosed workspace may pass into the air of the room via the open front sash closure 15 without first passing through filter 35. To limit this occurrence, and as previously discussed, outlet fan 40 is set to keep enclosed workspace 10 at a negative pressure differential relative to the ambient air, whereby to minimize unintentional airflow out open front sash closure 15. In addition, front sash closure 15 is typically arranged so as to minimize the size of the opening provided into enclosed workspace 10.

More particularly, and looking now at FIGS. 3 and 4, front sash closure 15 typically comprises a plurality of interconnected sliding panes 55. When enclosed workspace 10 is to be accessed by personnel, the bottommost pane 55 is lifted upwards, causing the interconnected sliding panes 55 to overlap in a cascading fashion whereby to progressively expose more and more of the enclosed workspace to the personnel. Thus, a conventional front sash closure 15 provides a variable-sized opening into enclosed workspace 10, with the variable-sized opening enlarging upward “from the bottom up”.

While conventional front sash closures 15 of the sort shown in FIGS. 1-4 have proven highly effective and highly reliable, they can also provide a sub-optimal solution in certain situations. More particularly, as noted above, conventional front sash closures 15 open “from the bottom up”. Thus, in situations where the objects to be manipulated (e.g., test tubes, beakers, etc.) sit directly on workbase 20 and are relatively short, the “bottom up” closure of conventional front sash closure 15 need only expose a relatively small region of enclosed workspace 10 in order to provide the personnel with appropriate access to the objects which are to be manipulated. However, in situations where the objects to be manipulated sit elevated above workbase 20 (e.g., on a stand or pole) and/or are relatively tall, the “bottom up” closure of conventional front sash closure 15 requires that a relatively large region of enclosed workspace 10 be exposed in order to provide the personnel with appropriate access to the objects which are to be manipulated. However, it will be appreciated that this is a sub-optimal solution, since it increases the possibility that hazardous substances may escape from enclosed workspace 10 through the open front sash closure 15. Moreover, with prior art fumehoods utilizing a conventional front sash closure 15, either the entire horizontal dimension of workspace 10 is closed off (i.e., front sash closure 15 is in the fully-down position), or the entire horizontal dimension of workspace 10 is fully accessible (i.e., front sash closure 15 is disposed in any partially-up position, exposing the entire horizontal dimension of workspace 10 from the left side of workpiece 10 to the right side of workspace 10). Stated somewhat differently, with the front sash closure 15 of prior art fumehoods, it is not possible to provide an opening into workspace 10 having a horizontal dimension that is smaller than the horizontal dimension of front sash closure 15.

It should also be appreciated that front sash closure 15 comprising the aforementioned cascading sliding panes 55 may result in a situation in which the sliding panes can fall down unexpectedly if inadvertently un-latched, creating a potentially dangerous situation for the user. And, there may be situations in which the user wishes to entirely remove a portion of the front sash closure 15 (e.g., one or more of the cascading sliding panes 55) which is not possible with prior art fumehoods utilizing cascading sliding panes.

It should also be appreciated that, with prior art fumehoods utilizing a “bottom up” type front sash closure 15 (e.g., one or more cascading sliding panes 55), upward movement of the panes of the front sash closure requires that the user lift the panes against the force of Earth's gravity, and such panes may be large and heavy depending on the materials utilized and the size/height of the fumehood. To counteract this, it is common in the art to employ counterweights (e.g., disposed in frame 12) which are connected to the upper portion of front sash closure 15 (or the upper portion of the sliding panes 55 thereof) via cabling. Such a construction reduces the force that the user must exert to move the panes upward (i.e., by virtue of the fact that the counterweights act to assist the user in raising the panes upward), however, such a construction requires cables and pulleys disposed in frame 12 that can be points of failure (e.g., cabling frays and eventually breaks) requiring expensive repairs or replacement.

It will be appreciated that the same issues can arise with respect to ducted fumehoods which use a conventional front sash closure 15 comprising the aforementioned cascading sliding panes 55.

Thus there is a need for an improved front sash closure for a ductless fumehood, and/or a ducted fumehood, which, (i) permits a user to close-off the bottom-most portion of the front opening of a fumehood while maintaining an opening for accessing the workspace intermediate the top and bottom of the front of the fumehood, (ii) permits the user to configure the fumehood such that the central opening for accessing the workspace comprises a horizontal dimension that is less than the horizontal dimension of the workspace, (iii) permits the front closure to be locked in an upward position, (iv) permits a portion of the front closure of the fumehood to be entirely removed from the fumehood, and (v) eliminates the complex counterweights utilized in prior art fumehoods.

### SUMMARY OF THE INVENTION

The present invention comprises the provision and use of an improved front sash closure for a ductless fumehood, and/or a ducted fumehood, which, among other things, (i) permits a user to close-off the bottom-most portion of the front opening of a fumehood while maintaining an opening for accessing the workspace intermediate the top and bottom of the front of the fumehood, (ii) permits the user to configure the fumehood such that the central opening for accessing the workspace comprises a horizontal dimension that is less than the horizontal dimension of the workspace, (iii) permits the front closure to be locked in an upward position, (iv) permits a portion of the front closure of the fumehood to be entirely removed from the fumehood, and (v) eliminates the complex counterweights utilized in prior art fumehoods.

In one preferred form of the present invention, there is provided a front closure for a fumehood comprising a workspace defined by a frame, the front closure comprising:
a front pane having a central opening formed therein; and
a movable pane configured to be disposed within the central opening so as to selectively close off a portion of the central opening, wherein the movable pane comprises a left side panel, a right side panel and a front panel extending between the left side panel and the right side panel.

In another preferred form of the present invention, there is provided a fumehood comprising:
a workspace defined by a frame and accessed by a front opening; and
a front closure mounted to the frame, the front closure comprising:
   a front pane mounted to the frame of the fumehood so as to partially cover the front opening of the fumehood, the front pane comprising a central opening formed therein; and
   a movable pane configured to be disposed within the central opening so as to selectively close off a portion of the central opening, wherein the movable pane comprises a left side panel, a right side panel and a front panel extending between the left side panel and the right side panel.

In another preferred form of the present invention, there is provided a method for handling hazardous substances, the method comprising:
providing a fumehood, the fumehood comprising:
   a workspace defined by a frame and accessed by a front opening; and
   a front closure mounted to the frame, the front closure comprising:
   a front pane mounted to the frame of the fumehood so as to partially cover the front opening of the fumehood, the front pane comprising a central opening formed therein; and
   a movable pane comprising a left side panel, a right side panel and a front panel extending between the left side panel and the right side panel;
positioning the movable pane within the central opening so as to selectively close off a portion of the central opening; and
handling the hazardous substance within the workspace of the fumehood.

### BRIEF DESCRIPTION OF THE DRAWINGS

These and other objects and features of the present invention will be more fully disclosed or rendered obvious by the following detailed description of the preferred embodiments of the invention, which are to be considered together with the accompanying drawings wherein like numbers refer to like parts and further wherein:

FIGS. 1-4 are schematic views showing a prior art ductless fumehood; and

FIGS. 5-27 are schematic views showing an improved front sash closure for a fumehood, formed in accordance with the present invention.

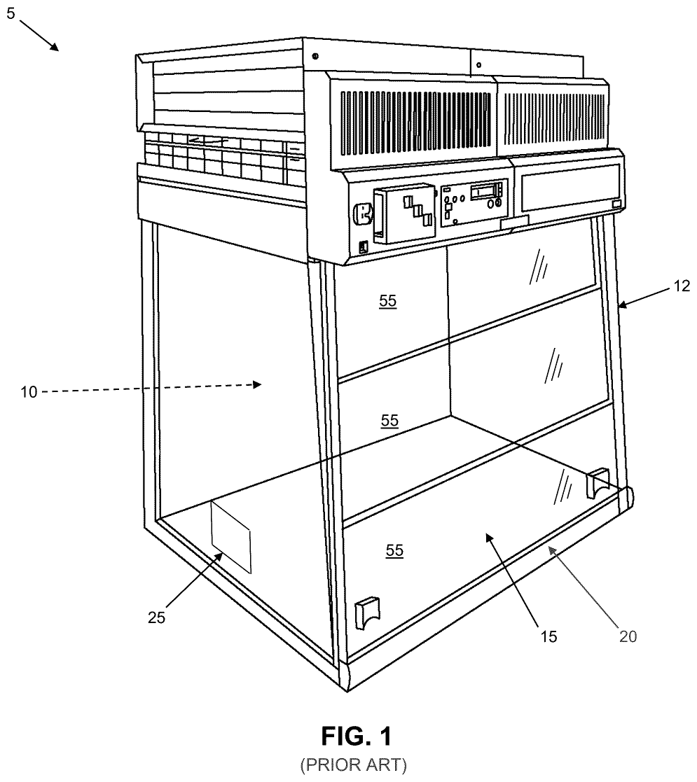

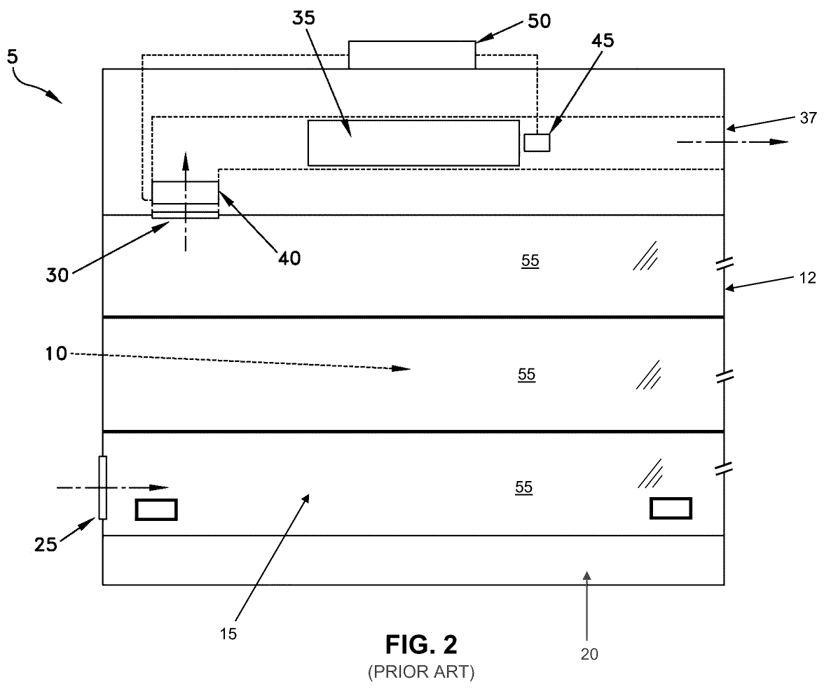

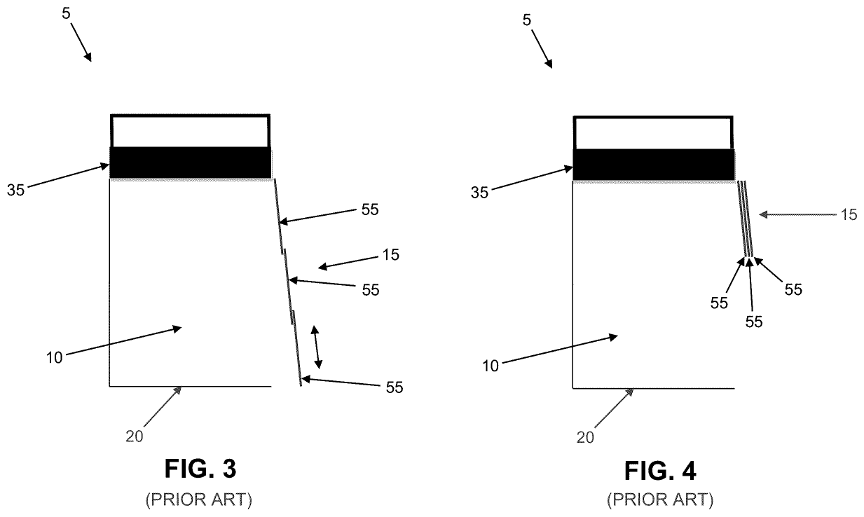

### DETAILED DESCRIPTION OF THE PREFERRED EMBODIMENTS

The present invention comprises the provision and use of an improved front sash closure for a ductless fumehood, and/or a ducted fumehood, which (i) permits a user to close-off the bottom-most portion of the front opening of a fumehood while maintaining an opening for accessing the workspace intermediate the top and bottom of the front of the fumehood, (ii) permits the user to configure the fumehood such that the central opening for accessing the workspace comprises a horizontal dimension that is less than the horizontal dimension of the workspace, (iii) permits the front closure to be locked in an upward position, (iv) permits a portion of the front closure of the fumehood to be entirely removed from the fumehood, and (v) eliminates the complex counterweights utilized in prior art fumehoods.

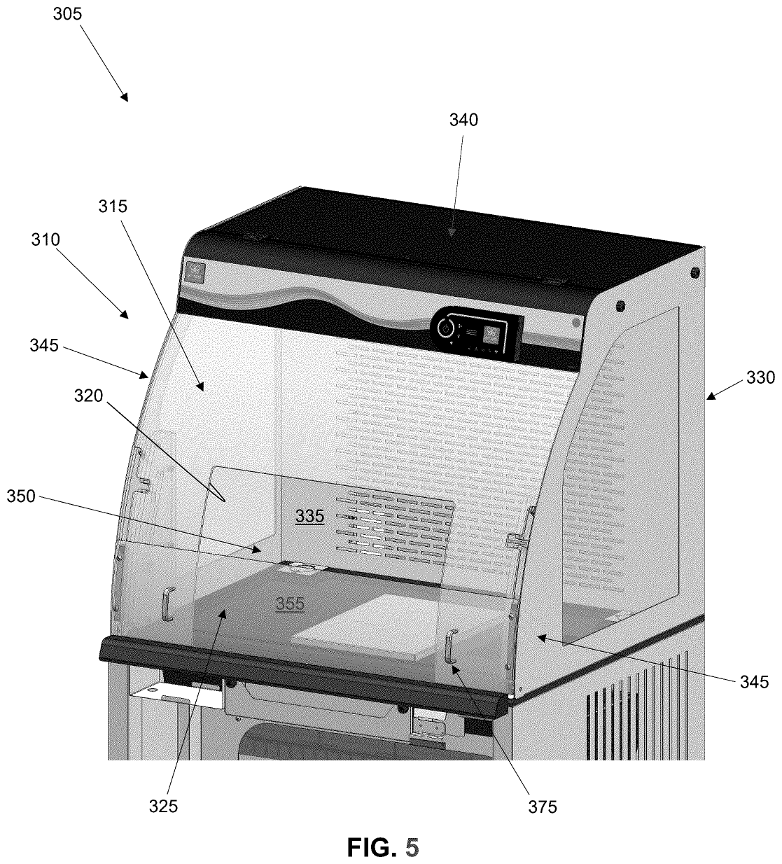

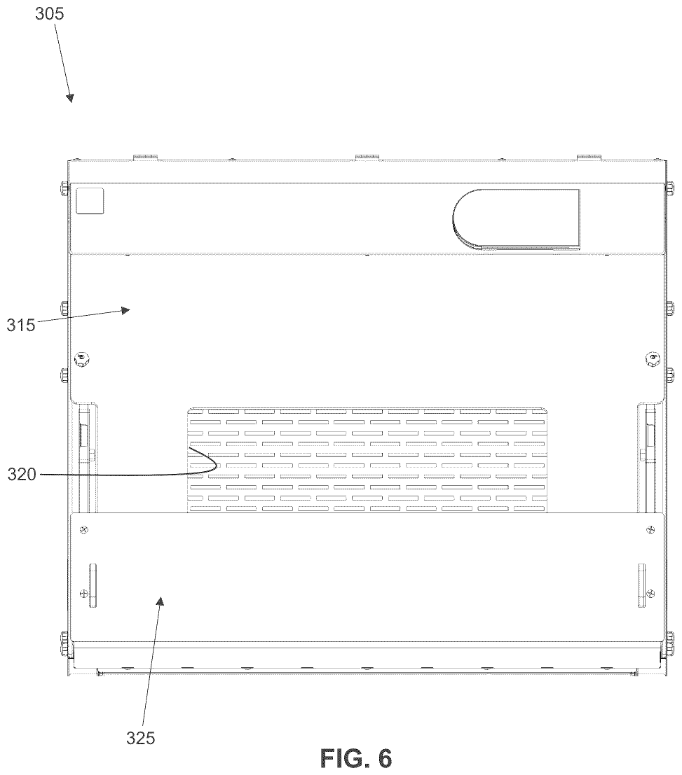

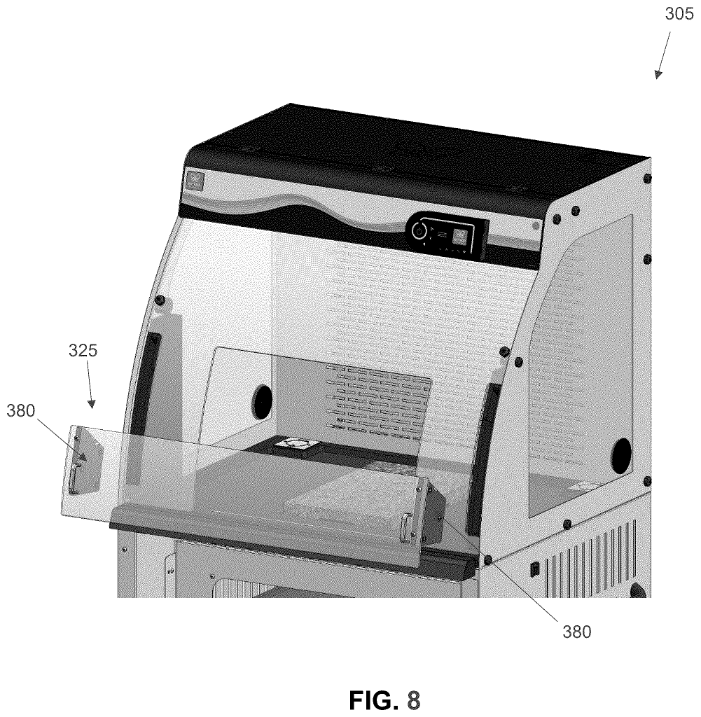

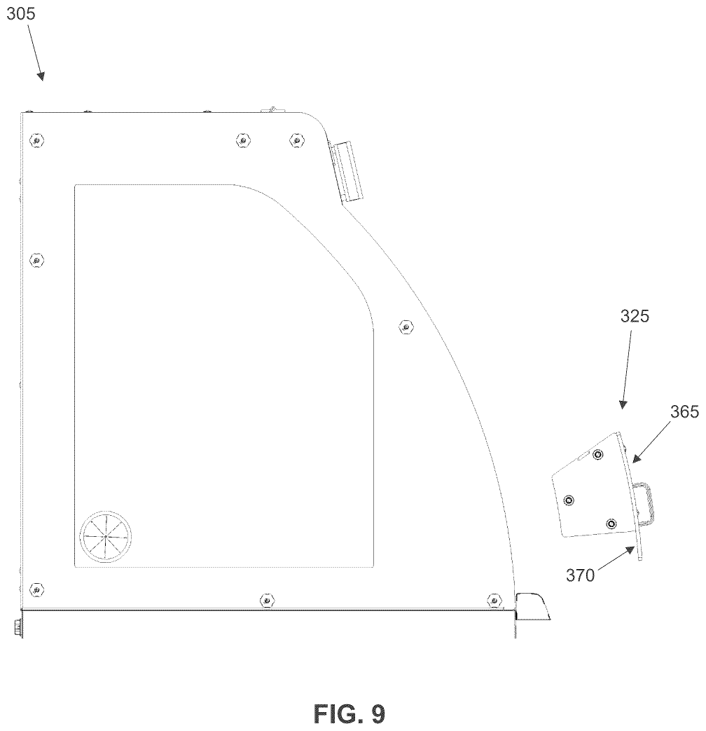

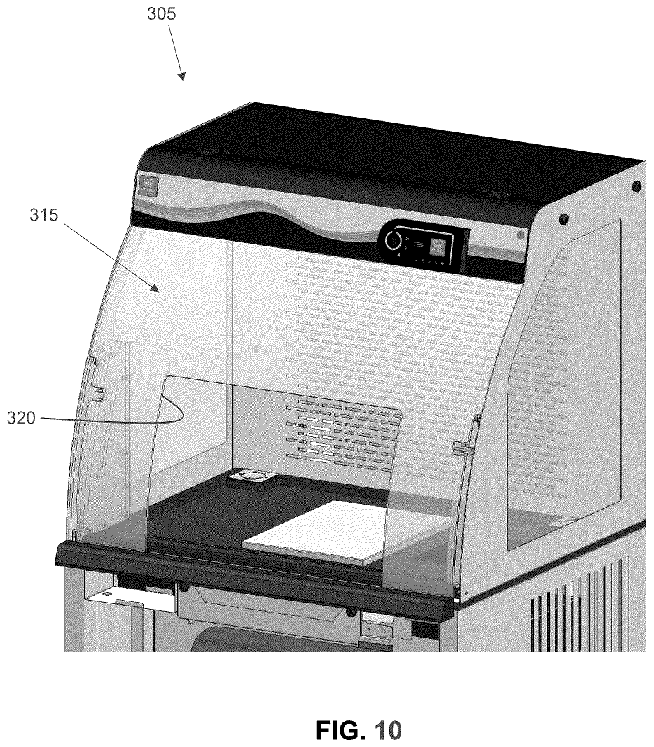

In one preferred embodiment of the invention, and looking now at FIGS. 5-11, there is shown a novel ductless fumehood 305.

Novel ductless fumehood 305 is generally similar to ductless fumehood 5 discussed above, however, with novel ductless fumehood 305, front sash closure 100 is replaced by a novel front closure 310.

Novel front closure 310 generally comprises a transparent arcuate pane 315 having a central opening 320 formed therein, and a movable pane 325 that is configured to be selectively moved relative to arcuate pane 315, and which is configured to be selectively removeable from fumehood 305, as will hereinafter be discussed in further detail.

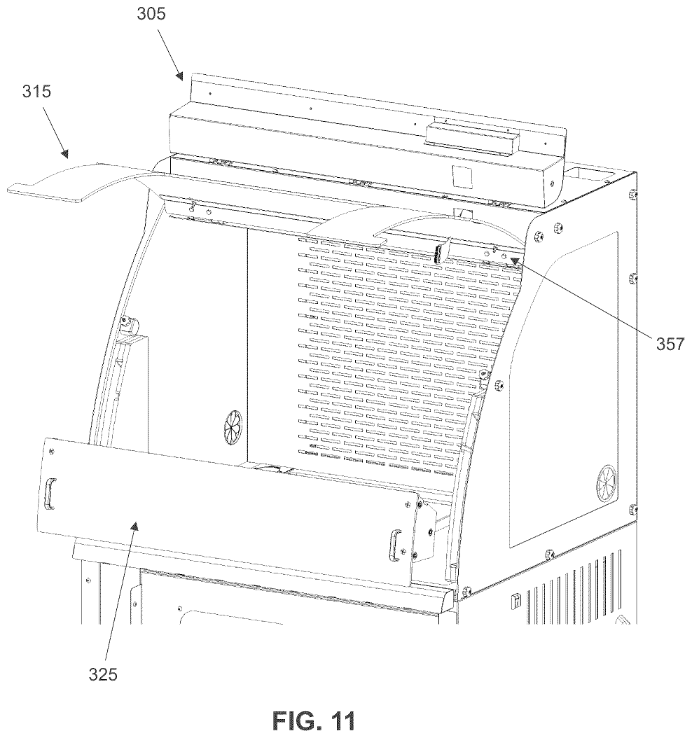

More particularly, and looking now at FIG. 5, fumehood 305 generally comprises a frame 330 defined by a back surface 335, an upper surface 340, and a pair of side surfaces 345. Arcuate pane 315 is mounted to frame 330 such that frame 330 and arcuate pane 315 together enclose and define a workspace 350 comprising a workspace surface 355. Arcuate pane 315 is preferably mounted to frame 330 via one or more hinge(s) 357 (FIG. 11) extending across a horizontal dimension of the fumehood so as to permit arcuate pane 315 to be rotated upward so as to access the entirety of workspace 350 (e.g., for cleaning workspace 350 and/or arcuate pane 315, etc.).

Central opening 320 in arcuate pane 315 is formed such that central opening 320 extends from workspace surface 355 (i.e., the lowermost edge of arcuate pane 315) up to a location between the lowermost edge of arcuate pane 315 and the uppermost edge of arcuate pane 315 (e.g., the midpoint). As a result of this construction, a person seeking to manipulate objects inside workspace 350 (e.g., scientific apparatus, chemicals, biological material, etc.) can reach through central opening 320 with their hands while standing outside of fumehood 305.

However, it has been recognized that in some circumstances, it is desirable to selectively close-off a portion of central opening 320 in order to facilitate safe handling of objects inside workspace 350. By way of example but not limitation, it has been recognized that in some circumstances, it is desirable to partially cover the lower portion (e.g., the lower half) of central opening 320 while manipulating objects inside workspace 350 so as to provide additional protection to the person standing outside of fumehood 305. Specifically, it has been recognized that maintaining negative air pressure inside the fumehood (i.e., in the workspace 350) is desirable because such negative air pressure ensures that hazardous fumes, etc., flow up and into the outlet of the fumehood where they are directed to a filter system or ducting to an area of safe release to atmosphere. Thus, it is important to maintain negative air pressure flow in workspace 350, ensuring that hazardous fumes, etc., cannot exit workspace 350 via opening 320 (thereby protecting the user standing just in front of opening 320 outside of the fumehood). It will be appreciated that one way to ensure negative pressure inside workspace 350, and hence air flow from the region outside of fumehood 305 and into central opening 320, is to reduce the total size of opening 320. Thus, movable pane 325 serves two related protective functions: movable pane 325 (i) protects the user from possible “splashing” and spills of materials contained within workspace 350 by providing a physical barrier, and (ii) protects the user from possible escape of hazardous fumes, etc., from workspace 350 via central opening 320 by reducing the total open area of central opening 320 and thereby facilitating the maintaining of negative air pressure within workspace 350.

To that end, movable pane 325 is configured to be selectively mounted to (or removed from) fumehood 305, as will hereinafter be discussed in further detail.

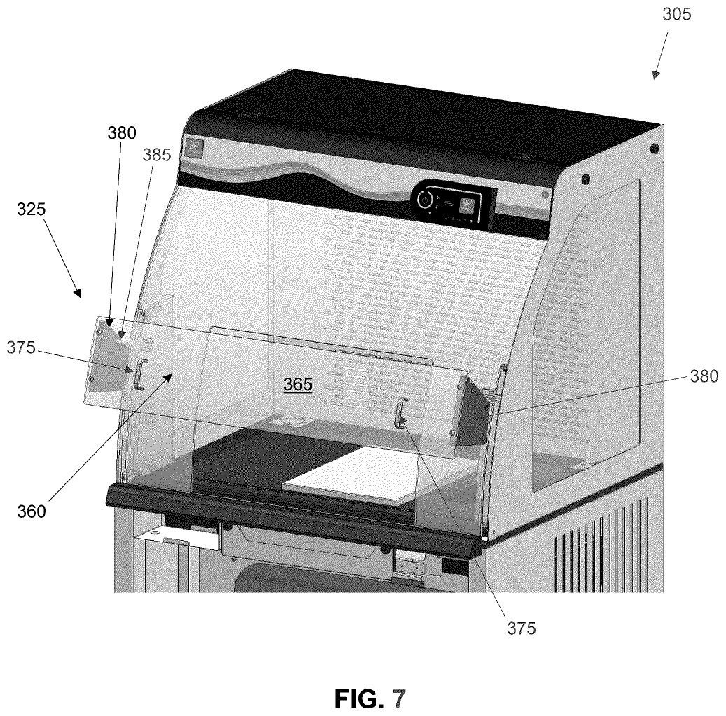

More particularly, and looking now at FIGS. 7-11, movable pane 325 comprises a front pane 360 having a front surface 365 and a rear surface 370. It will be appreciated that front pane 360 may comprise a transparent material (e.g., plexiglass or similar) of the type that will be apparent to one of skill in the art in view of the present disclosure. A pair of handles 375 are mounted to front surface 365 of front pane 360 so as to permit a user to grasp movable pane 325 and selectively mount (or remove) movable pane 325 to (or from) fumehood 305 and/or move movable pane 325 between a lower position and an upper position, as will hereinafter be discussed in further detail.

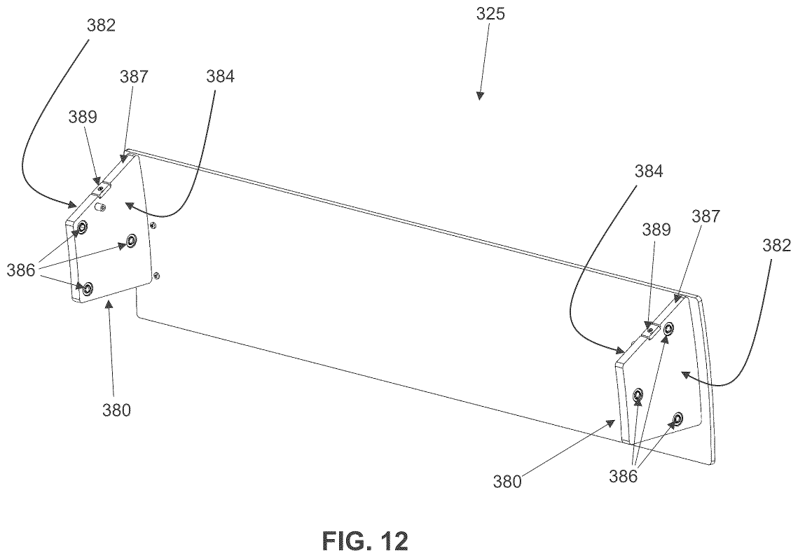

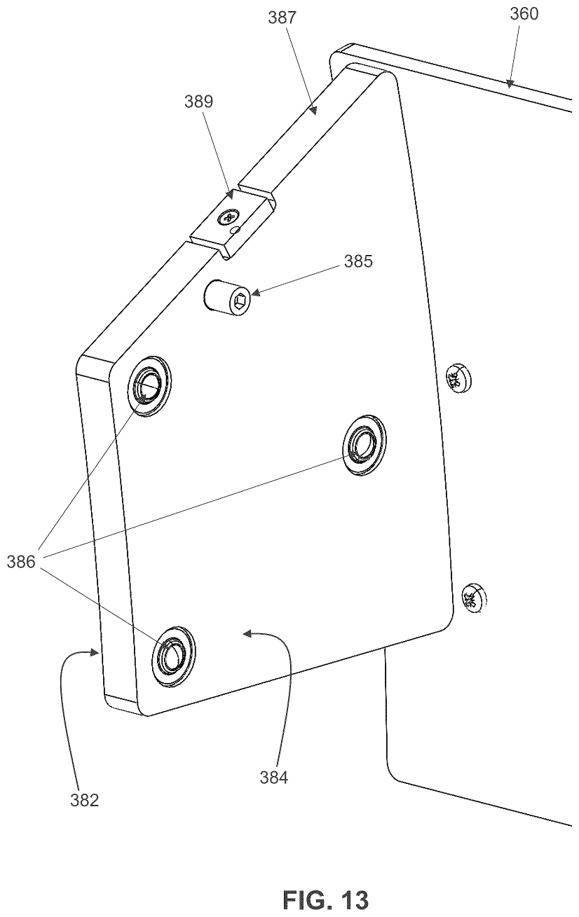

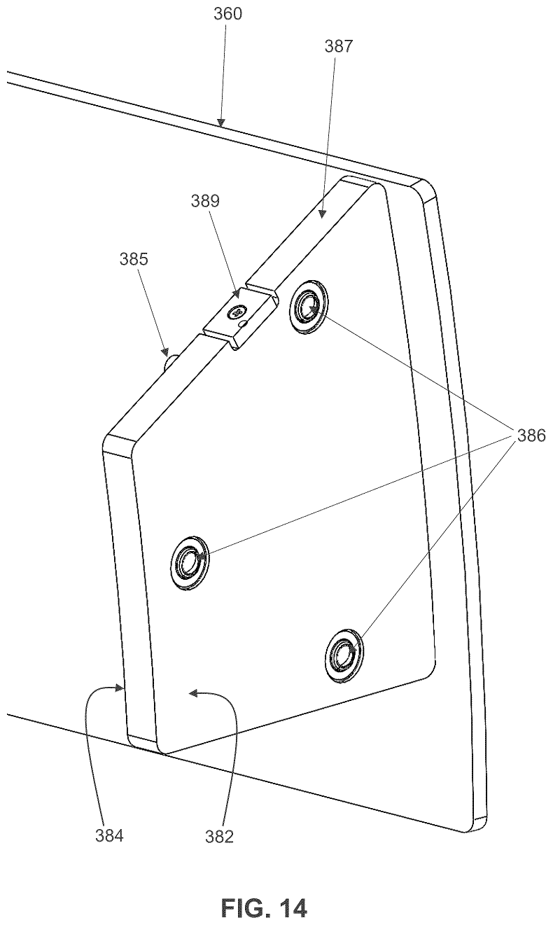

A pair of guides 380 are mounted to rear surface 370 of front pane 360 of movable pane 325 so as to be disposed generally perpendicular thereto. Each of guides 380 comprises an outboard surface 382 which faces side surface 345 of frame 330 when movable pane 325 is mounted to frame 330, and an inboard surface 384 which faces central opening 320 when movable pane 325 is mounted to frame 330. See FIG. 12. Inboard surface 384 of each guide 380 comprises at least one mounting pin 385 extending laterally outboard (i.e., perpendicular) therefrom for facilitating mounting of movable pane 325 to frame 330, as will hereinafter be discussed in further detail. In one preferred embodiment of the invention, inboard surface 384 and/or outboard surface 382 of each guide 380 comprises a plurality of bearing elements 386 (e.g., ball bearings retained with a collet so as to rotate freely within the collet) for facilitating smooth movement of movable pane 325 relative to frame 330 when mounted thereto, as will be apparent to one of skill in the art in view of the present disclosure.

Each guide 380 further comprises an upper surface 387 disposed between, and extending perpendicular to, outboard surface 382 and inboard surface 384 of each guide 380. Upper surface 387 of each guide 380 preferably comprises a magnetic clasp 389 (FIG. 12) for mating with and selectively magnetically mounting movable pane 325 to a ferrous metal counterpart of frame 330, as will hereinafter be discussed in further detail.

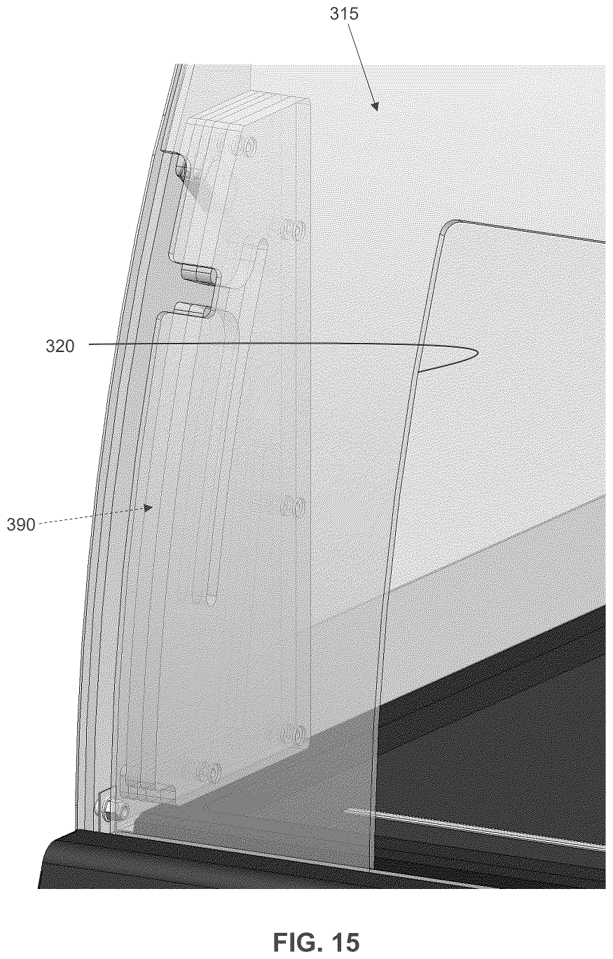

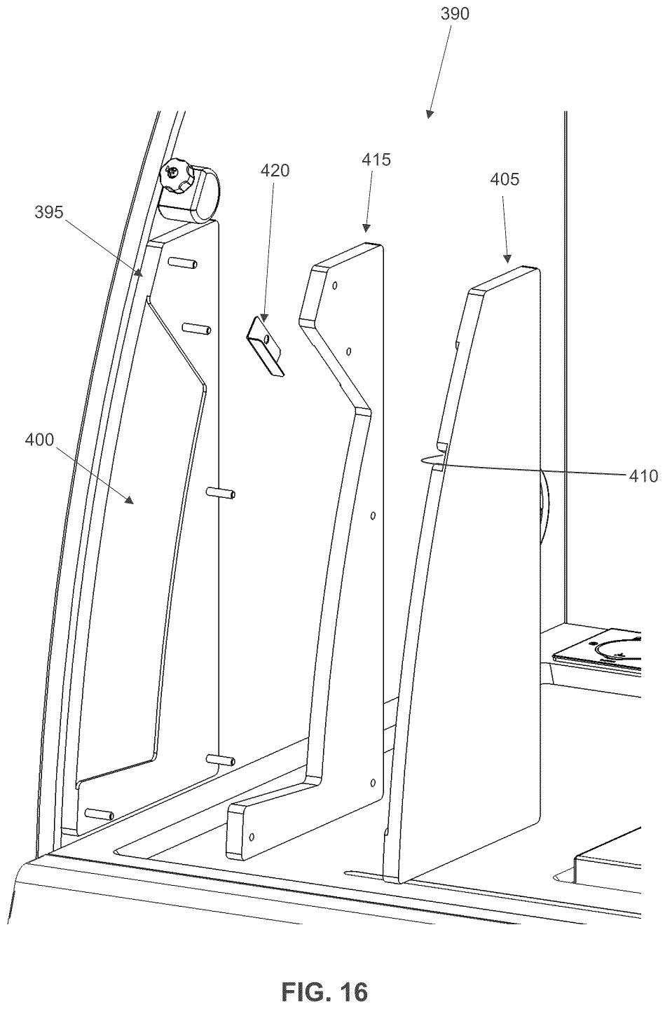

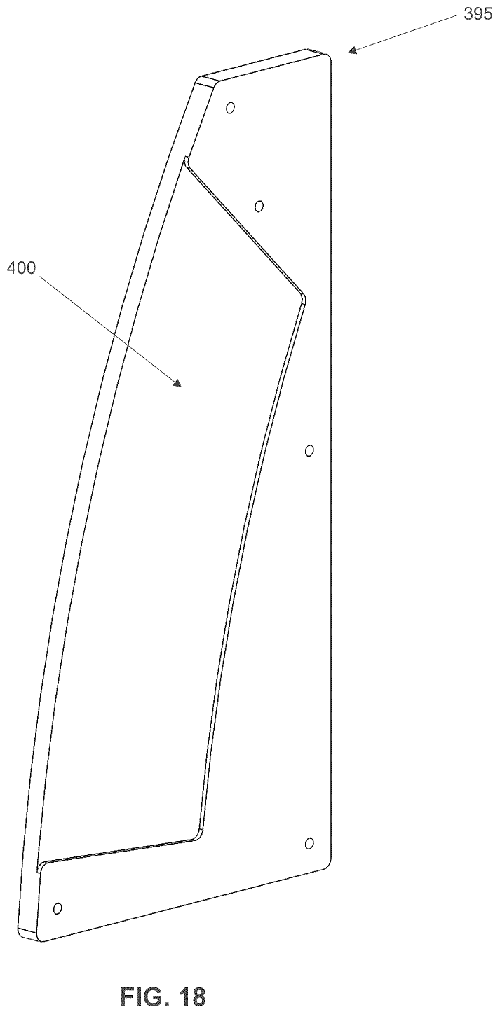

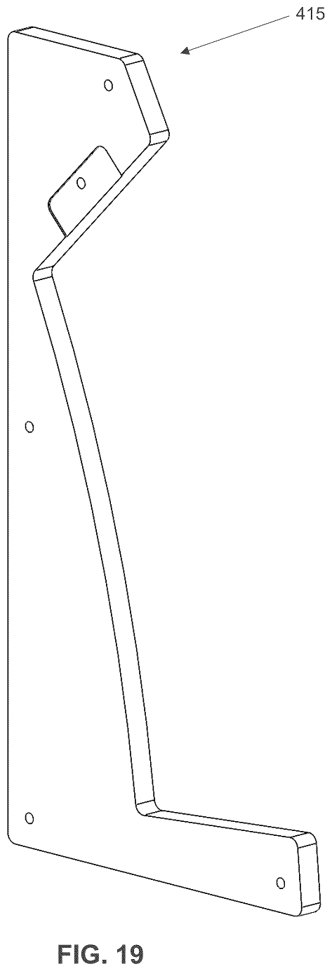

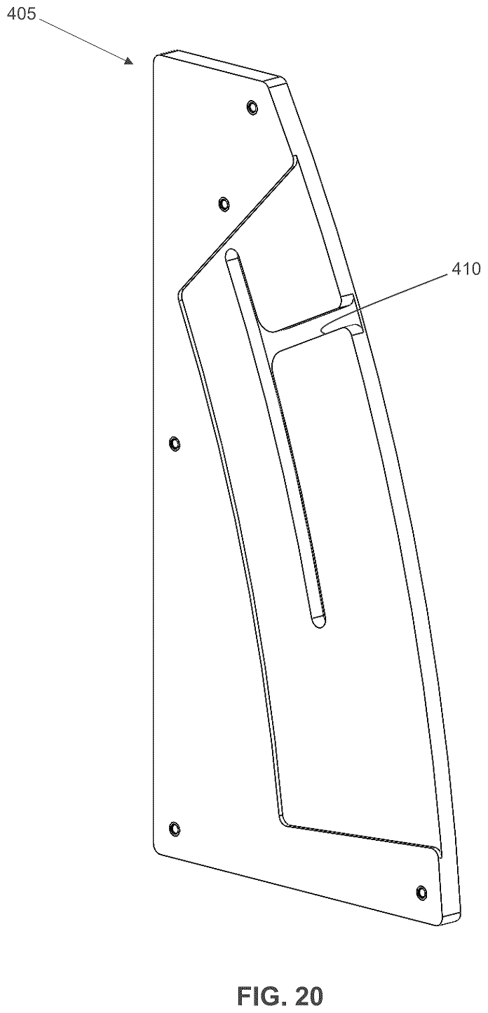

Looking now at FIGS. 15-21, a pair of mounting brackets 390 are mounted to each of side surfaces 345 of frame 330 of fumehood 305 on the inner surface thereof. Each mounting bracket 390 comprises an outboard plate 395 comprising a central recessed region 400, an inboard plate 405 comprising a generally T-shaped cutout 410 formed on the surface thereof that faces central recessed region 400 of outboard plate 395, and a spacer plate 415 disposed between outboard plate 395 and inboard plate 405. A ferrous metal retainer bracket 420 is mounted to spacer plate 415 such that a ferrous metal portion of bracket 420 is disposed at the uppermost region of T-shaped cutout 410, whereby to receive and magnetically mount to magnetic clasp 389 of each guide 380, as will hereinafter be discussed in further detail.

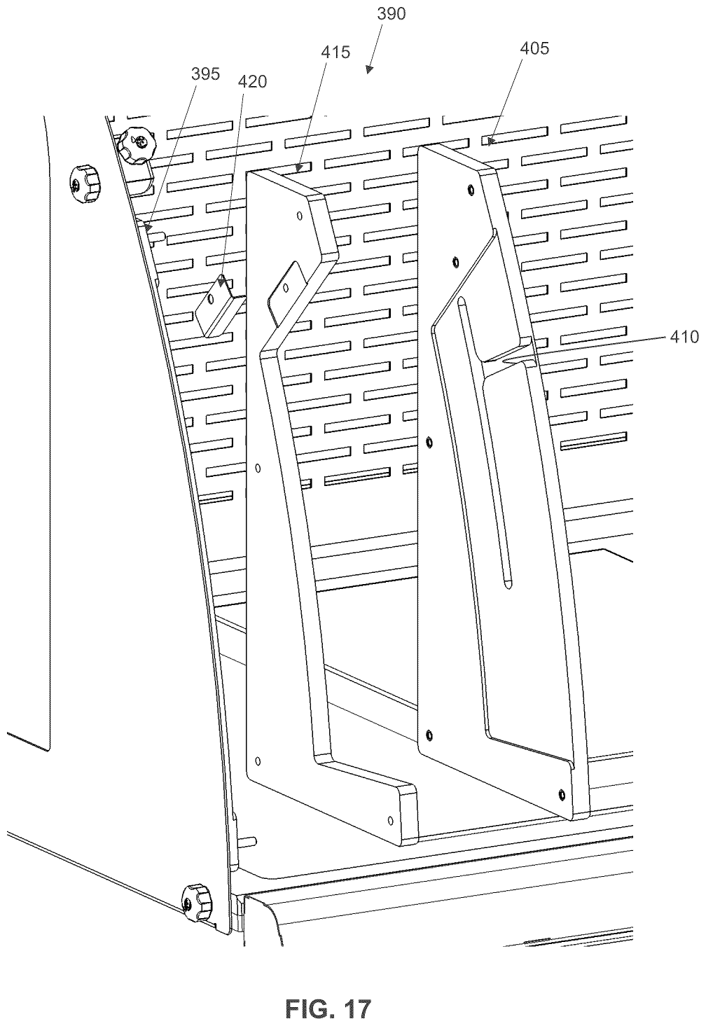

Looking now at FIGS. 17, 20 and 21, when outboard plate 395, spacer plate 415 and inboard plate 405 are mounted together so as to form mounting brackets 390, central recessed region 400 of outboard plate 395 and T-shaped cutout 410 of inboard plate 405, spaced away from one another via spacer plate 415, present a generally T-shaped groove 425. T-shaped groove 425 comprises a first extension 430, a downwardly-extending second extension 435 disposed generally perpendicular to, and opening on, first extension 430, and an upwardly-extending third extension 440 disposed generally perpendicular to, and opening on, first extension 430.

Mounting pins 385 of guides 380 of movable pane 325 are sized to be received in T-shaped groove 425, whereby to permit movable pane 325 to be mounted to mounting brackets 390, and hence to frame 330, so as to selectively close off an upper portion or a lower portion of central opening 320, as will hereinafter be discussed in further detail.

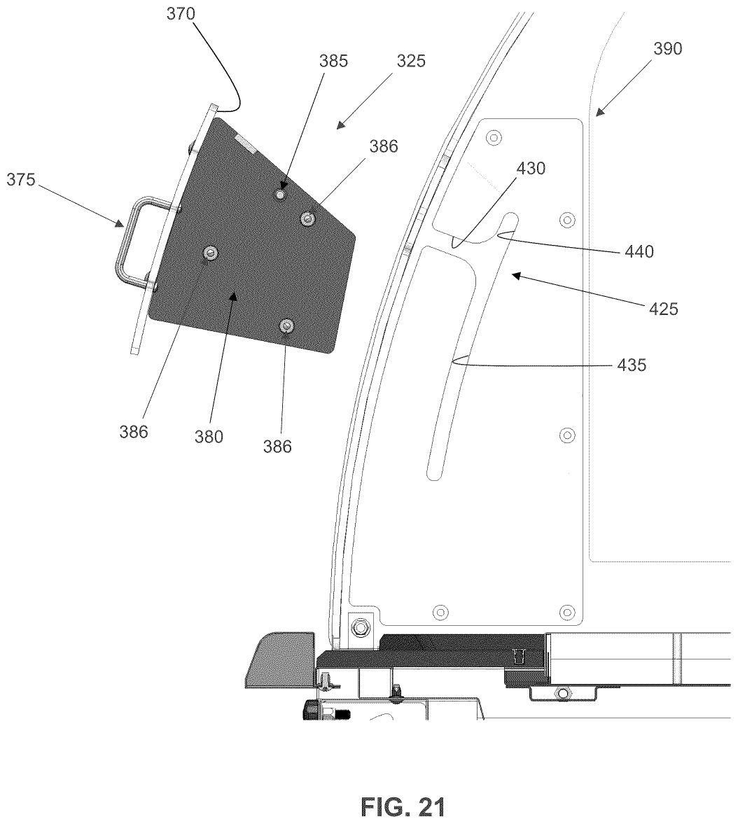

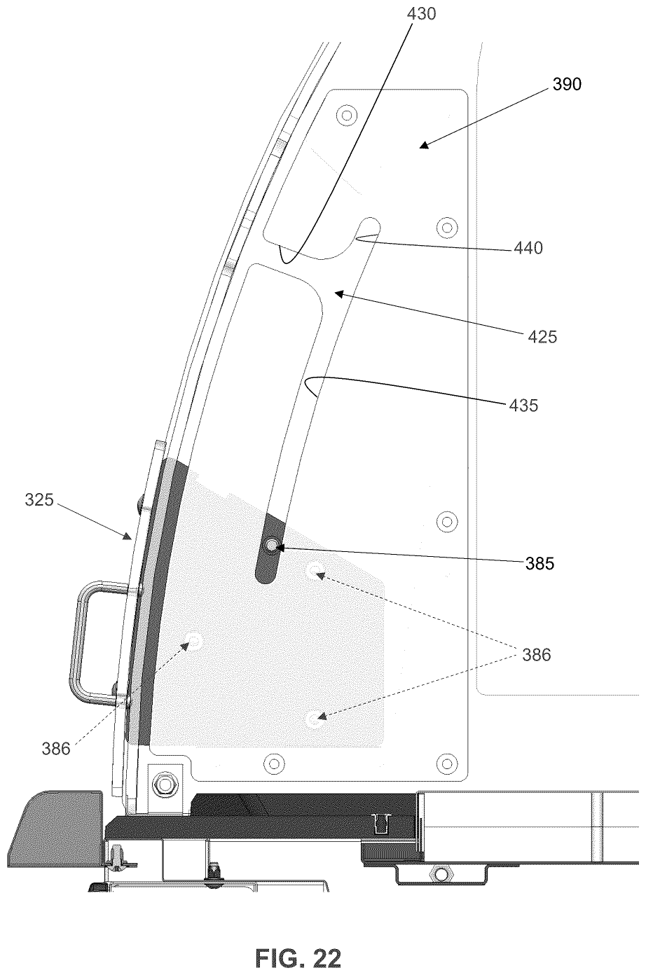

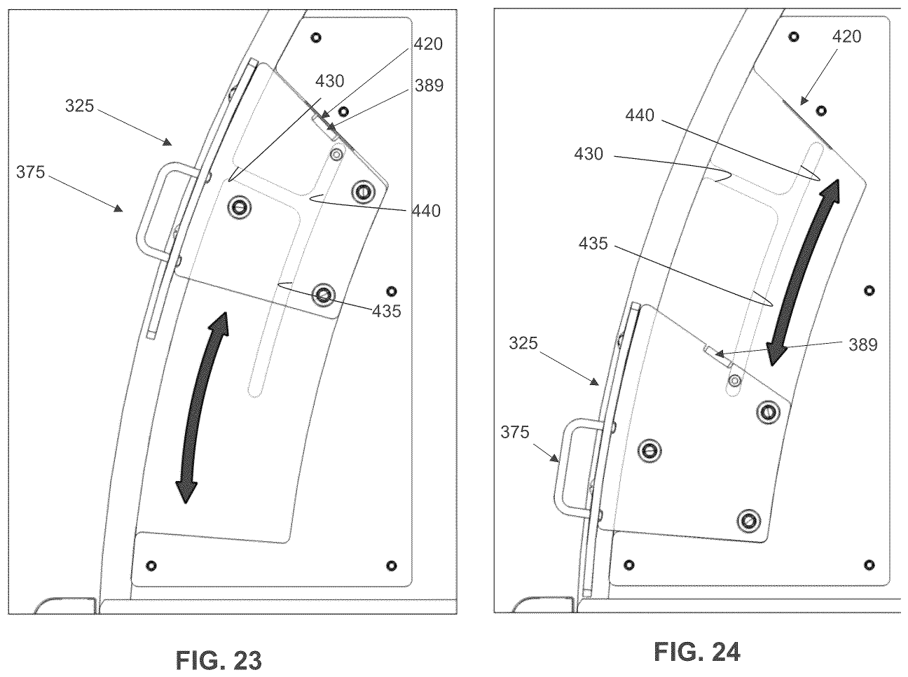

More particularly, a user may mount movable pane 325 to fumehood 305 so as to close off a portion of central opening 320 by grasping movable pane 325 by handles 375, and then moving movable pane 325 such that mounting pins 385 are aligned with first extension 430 of T-shaped groove 425 (FIG. 21). The user can then move movable pane 325 towards arcuate pane 315 so that mounting pins 385 are received in first extension 430 of T-shaped groove 425. Once mounting pins 385 have been advanced along first extension 430 to the location at which third extension 440 of T-shaped groove 425 intersects with first extension 430, the user can move movable pane 325 upward so as to move mounting pins 385 into third extension 440, and the user can move movable pane 325 upwards until magnetic clasp 389 on upper surface 387 of each guide 380 of movable pane 325 magnetically engages, and mounts to, ferrous metal retainer bracket 420 of each respective mounting bracket 390. Once magnetic clasp 389 is mounted to ferrous metal retainer bracket 420, movable pane 325 is mounted to frame 330 in the upper-most position (FIG. 23), permitting direct access to workspace surface 355 via central opening 320. It is important to note that if the user were to release hold of handles 375 after mounting movable pane 325 in its upper-most position, movable pane 325 would remain locked to frame 330 in its upper-most position, whereby to close off the upper portion of central opening 320, but permit hands-free direct access to workspace surface 355 via central opening 320.

It should be appreciated that it is possible to move movable pane 325 from its upper-most position to its lower-most position so as to permit direct access to an upper portion of workspace 350 via central opening 320. Specifically, once movable pane 325 is disposed in its upper-most position (as shown in FIG. 23) so as to be magnetically mounted to ferrous metal retainer brackets 420 in the manner discussed above, the user can slide movable pane 325 downward such that mounting pins 385 move along third extension 440 (e.g., by applying sufficient downward force to movable pane 325 to disengage the magnetic connection between magnetic clasp 389 and ferrous metal retainer brackets 420) and then continue sliding movable pane 325 downward such that mounting pins 385 continue into second extension 435 until movable pane 325 is disposed in its lower-most position. T-shaped groove 425 is formed such that when the user releases hold of handles 375 after moving movable pane 325 to its lower-most position, movable pane 325, under the power of Earth's gravity, remains disposed at a location that closes off the lower portion of central opening 320, but still permits access to an upper portion of workspace 350. See FIG. 24.

It should be appreciated that T-shaped groove 425 is formed to have a size and geometry that facilitates the mounting of movable pane 325 to frame 330 in a manner which closes off the upper portion of central opening 320 when movable pane 325 is mounted to frame 330 in its upper-most position while still permitting access to workspace surface 355, and which closes off the lower portion of central opening 320 when movable pane 325 is mounted to frame 330 in its lower-most position while still permitting access to an upper portion of workspace 350.

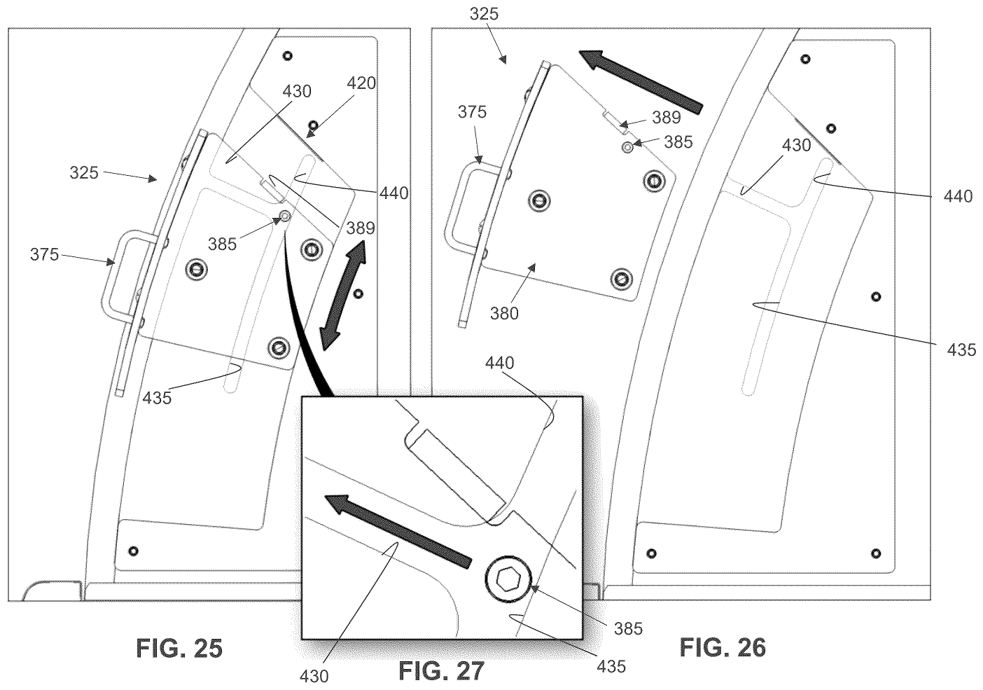

It should also be appreciated that movable pane 325 of the present invention is also constructed such that movable pane 325 can be entirely removed from fumehood 305 (whereby to leave central opening 320 of arcuate pane 315 unobstructed). More particularly, and looking now at FIGS. 25-27, if desired, the user can move movable pane 325 in the manner discussed above such that mounting pins 385 of movable pane 325 are disposed in alignment with first extension 430 of T-shaped groove 425. The user can then pull handles 375 of movable pane 325 so as to move mounting pins 385 into first extension 430, continuing to pull movable pane 325 away from arcuate pane 315 until movable pane 325 is completely removed from, and separated from, fumehood 305.

Finally, it should be appreciated that as movable pane 325 is moved relative to arcuate pane 315 in the manner discussed above, guides 380 of movable pane 325 are received in the gap between outboard plate 395 and inboard plate 405 (i.e., the gap defined by spacer plate 415). As this occurs, bearing elements 386 disposed on outboard surface 382 of guides 380 and/or inboard surface 384 of guides 380 engage and roll along central recessed region 400 of outboard plate 395 of mounting brackets 390, and T-shaped cutout 410 of inboard plate 405 of mounting brackets 390, respectively. As a result of this construction, movable pane 325 is able to move smoothly relative to arcuate pane 415 and undesirable binding of mounting pins 385 within T-shaped grooves 425 is avoided.

It is also important to note that due to the shape of T-shaped groove, movable pane 325 may not be removed, either accidentally, or on purpose, from frame 330 when movable pane 325 is disposed in its upper-most position or its lower-most position.

Movable pane 325 may only be mounted to, or removed from, frame 330 by moving mounting pins 385 into, and out of, first extension 430 of T-shaped groove.

### Modifications Of The Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A front closure for a fumehood comprising a workspace defined by a frame, the front closure comprising:
a front pane having a central opening formed therein; and
a movable pane configured to be disposed within the central opening so as to selectively close off a portion of the central opening, wherein the movable pane comprises a left side panel, a right side panel and a front panel extending between the left side panel and the right side panel.

2. The front closure of claim 1 wherein the frame of the fumehood comprises a left side mounting bracket comprising a groove and a right side mounting bracket comprising a groove, wherein the left side panel of the movable frame comprises a mounting pin sized to be received in the groove of the left side mounting bracket and the right side panel of the movable frame comprises a mounting pin sized to be received in the groove of the right side mounting bracket.

3. The front closure of claim 2 wherein each of the grooves comprises a horizontal extension and a substantially vertical extension.

4. The front closure of claim 3 wherein each of the grooves comprises a T-shaped groove.

5. The front closure of claim 3 wherein when the movable pane is disposed that the mounting pins of the movable frame are disposed in bottom-most portions of the vertical extensions of the grooves, the movable pane extends across a lower portion of the central opening, and when the mounting pins of the movable pane are disposed in upper-most portions of the vertical extensions of the grooves, the movable pane extends across an upper portion of the central opening.

6. The front closure of claim 1 wherein the movable pane is configured to be magnetically connected to the frame of the fumehood so as to hold the movable pane in a desired position within the central opening of the front pane.

7. The front closure of claim 1 wherein the front panel of the movable pane comprises a width greater than a width of the central opening of the front pane.

8. The front closure of claim 1 wherein the movable frame comprises at least one magnet for magnetically connecting the movable frame to a ferrous metal surface on the frame of the fumehood.

9. The front closure of claim 1 wherein the frame of the fumehood comprises at least one magnet for magnetically connecting the movable frame to a ferrous metal surface on the movable frame.

10. The front closure of claim 2 wherein the left side panel of the movable frame comprises a magnet for mounting to a ferrous metal surface on the left side mounting bracket and the right side panel of the movable frame comprises a magnet for mounting to a ferrous metal surface on the right side mounting bracket.

11. The front closure of claim 1 wherein the front pane comprises a transparent, arcuate pane.

12. The front closure of claim 1 wherein the front pane is hingedly mounted to the frame of the fumehood so as to be rotatable relative thereto.

13. The front closure of claim 1 wherein the movable pane is substantially transparent.

14. The front closure of claim 1 wherein the front panel of the movable pane comprises a handle.

15. The front closure of claim 1 wherein the front panel comprises a pair of handles.

16. The front closure of claim 2 wherein the left side panel and the right side panel each comprise an outboard surface and an inboard surface, and further wherein at least one of the outboard surface and the inboard surface comprises a plurality of bearing elements for slidably engaging the mounting brackets.

17. A fumehood comprising:
a workspace defined by a frame and accessed by a front opening; and
a front closure mounted to the frame, the front closure comprising:
a front pane mounted to the frame of the fumehood so as to partially cover the front opening of the fumehood, the front pane comprising a central opening formed therein; and
a movable pane configured to be disposed within the central opening so as to selectively close off a portion of the central opening, wherein the movable pane comprises a left side panel, a right side panel and a front panel extending between the left side panel and the right side panel.

18. The fumehood of claim 17 wherein the frame of the fumehood comprises a left side mounting bracket comprising a groove and a right side mounting bracket comprising a groove, wherein the left side panel of the movable frame comprises a mounting pin sized to be received in the groove of the left side mounting bracket and the right side panel of the movable frame comprises a mounting pin sized to be received in the groove of the right side mounting bracket.

19. A method for handling hazardous substances, the method comprising:
providing a fumehood, the fumehood comprising:
a workspace defined by a frame and accessed by a front opening; and
a front closure mounted to the frame, the front closure comprising:
a front pane mounted to the frame of the fumehood so as to partially cover the front opening of the fumehood, the front pane comprising a central opening formed therein; and
a movable pane comprising a left side panel, a right side panel and a front panel extending between the left side panel and the right side panel;
positioning the movable pane within the central opening so as to selectively close off a portion of the central opening; and
handling the hazardous substance within the workspace of the fumehood.

20. The method of claim 19 wherein the frame of the fumehood comprises a left side mounting bracket comprising a groove and a right side mounting bracket comprising a groove, wherein the left side panel of the movable frame comprises a mounting pin sized to be received in the groove of the left side mounting bracket and the right side panel of the movable frame comprises a mounting pin sized to be received in the groove of the right side mounting bracket.

21. The method of claim 20 further comprising moving the movable pane between an upper-most position in which the movable pane extends across an upper portion of the central opening and a lower-most position in which the movable pane extends across a lower portion of the central opening.

22. The method according to claim 19 further comprising removing the movable pane from the central opening.
